(19) United States
(12) Patent Application Publication
(10) Pub. No.: US 2005/0239544 A1
(43) Pub. Date: Oct. 27, 2005

(54) Self-contained integrated audio, lighting and surveillance system

(76) Inventors: Paul C. Steelman, Las Vegas, NV (US); Jon Champelli, Las Vegas, NV (US); David Tibbitts, Las Vegas, NV (US); Steve Anderson, Las Vegas, NV (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 10/833,505

(22) Filed: Apr. 27, 2004

(51) Int. Cl. G06F 17/00

(52) U.S. Cl. 463/29

(57) ABSTRACT

An integrated audio, lighting and surveillance system having a base, a support structure mounted to the base, and a component enclosure mounted on the support structure. The component enclosure includes a series of mounting locations, each configured to receive a modular component usable for supporting a gaming table. The integrated audio, lighting and surveillance system may also include a game tracking system as well as a dealer calling system.

### FIELD OF THE INVENTION

The present invention relates generally to audio, lighting and surveillance systems, and more particularly, to a self-contained integrated audio, lighting and surveillance system.

### BACKGROUND OF THE INVENTION

Presently, the provision of audio, lighting and surveillance features for a facility such as a casino or a hotel requires the fixation of various components to a wall or ceiling. These components may include one or more video and still cameras, speakers, microphones, and lights. The choice and configuration of the various components of the system is dictated by the specific purpose of the facilities. For example, in a casino environment, it is often desirable for the operator of the casino to monitor the gaming tables for surveillance purposes while also being able to provide lighting and audio (e.g., music or announcements from the dealers) to the patrons at the games. Typically, one or more video cameras are installed in or hung from the ceilings in an unobtrusive manner as possible, while speakers and light fixtures are mounted separately, either in the same fashion as the cameras or hung on one or more walls.

Further, to support gaming tables, one or more work tables are often located near or in a cluster of gaming tables. These work tables also require audio, lighting and surveillance systems as well as communication capability. Often, requirements for the work table are different from the gaming tables. For example, work tables require task lighting while gaming tables require both task lighting and general lighting. In addition, work tables require communication capability provided by such devices as phone or computers so that pit bosses or managers may communicate with other work tables, surveillance, or other departments in the casino. Further still, work tables may have other peripherals such as printers, card scanners, and a myriad of other devices that need power and communications. The creation and installation of a system that satisfies the various needs of both gaming and work tables require a complex, lengthy and expensive process.

Other issues presented by the need to support both gaming and work tables with audio, video, communication and surveillance capabilities include:

The components have to be permanently and securely fixed, restricting the placement of the components to locations where a stable structure is present.

Each component or a cluster of components must be secured to a wall or the ceiling, which means that even the most simple installations are labor intensive.

Cable runs must be made to each component or cluster of components, often at great expense and time as the cables are hidden in walls or ceilings so as not to be unsightly.

Once installed, reconfiguration of the components or cluster of components is difficult.

Where there are high ceilings, long cables must be used to suspend components, which are unsightly and detract from the ability of the interior designer to have an “open” interior.

There has been a long felt need to overcome the foregoing issues.

### SUMMARY OF THE PREFERRED EMBODIMENTS

The present invention provides an integrated audio, lighting and surveillance system that is self-contained, free-standing and configurable to support different gaming tables.

In one preferred embodiment, the integrated audio, lighting and surveillance system includes a base, a support structure mounted to the base, and a component enclosure mounted on the support structure. The component enclosure includes a series of mounting locations, each configured to receive a modular component usable for supporting a gaming table.

In another preferred embodiment, the integrated audio, lighting and surveillance system includes a base, a support structure mounted to the base, and a component enclosure mounted on the support structure, where the component enclosure has a series of mounting panels, each panel configured to receive a modular component configured to support a gaming table.

In yet another preferred method of the present invention, a free-standing structure is provided that includes a base, a component enclosure having a plurality of mounting locations for mounting modular components, and a support structure coupling the component enclosure to the base. A component is selected from a group consisting of a camera, a light fixture, an audio speaker, a microphone, a speaker, a communications device, a power supply, and an alert system. Further, the component is installed in the component enclosure.

It is an object of the present invention to provide a flexible and reconfigurable system for providing audio, lighting and/or surveillance features for gaming tables.

It is also an object of the present invention to provide a free-standing, self-contained system for providing audio, lighting and/or surveillance features for gaming tables.

It is yet another object of the present invention to provide a lighting system that includes both configurable task lighting and ambient lighting.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which:

FIG. 1 is a front elevational view of an integrated audio, lighting and surveillance system configured in accordance with a preferred embodiment of the present invention;

FIG. 2 is a side view of the integrated audio, lighting and surveillance system of FIG. 1;

FIG. 3 is a top plan view of the integrated audio, lighting and surveillance system of FIG. 1, with the interchangeable modules shown in an exemplary configuration in accordance with one embodiment of the present invention;

FIG. 4 illustrates the various modules that may be used in the integrated audio, lighting and surveillance system of FIG. 1;

FIG. 5 is a bottom up view of one of the wings of the integrated audio, lighting and surveillance system of FIG. 1;

FIG. 6 is a top view of various embodiments of dust covers and ventilation grills that may be used with the integrated audio, lighting and surveillance system of FIG. 1;

FIG. 7 illustrates a light diffusion panel that may be used with the integrated audio, lighting and surveillance system of FIG. 1;

FIG. 8 is a cross-sectional view of the wing of the integrated audio, lighting and surveillance system of FIG. 1;

FIG. 9 is an elevational view of an exemplary wiring/cable run for the components of the integrated audio, lighting and surveillance system of FIG. 1;

FIG. 10 is a top view of the exemplary wiring/cable run for the components of the integrated audio, lighting and surveillance system of FIG. 1;

FIG. 11 is a block diagram of an audio system configured in accordance with one embodiment of the present invention for use in the integrated audio, lighting and surveillance system of FIG. 1;

FIG. 12 is a elevational cross-section view of a base configured in accordance with one embodiment of the present invention for use in the integrated audio, lighting and surveillance system of FIG. 1;

FIGS. 13A-13E are cross-sectional views of lines A-A, B-B, C-C, D-D, and E-E of the base of FIG. 12;

FIG. 14 is a top plan view of the configuration of the table surface of the base of FIG. 12;

FIG. 15 is a top plan view of the integrated audio, lighting and surveillance system of FIG. 1 used with an exemplary configuration of gaming tables;

FIG. 16A is a cross-sectional view of an arm configured in accordance with one embodiment of the present invention for use in the integrated audio, lighting and surveillance system of FIG. 1;

FIG. 16B is a cross-sectional view of an arm configured in accordance with one embodiment of the present invention for use in the integrated audio, lighting and surveillance system of FIG. 1;

FIG. 17 is a cross-sectional view of a support configured in accordance with one embodiment of the present invention along with a side elevation view of its placement in the integrated audio, lighting and surveillance system of FIG. 1;

FIG. 17 is a cross-sectional view of a support configured in accordance with one embodiment of the present invention along with a side elevation view of its placement in the integrated audio, lighting and surveillance system of FIG. 1;

FIG. 18 is a side elevational view of the integrated audio, lighting and surveillance system of FIG. 1 illustrating the integration of a support structure configured in accordance with one embodiment of the present invention; and,

FIG. 19 illustrates the support structure of FIG. 18.

Like numerals refer to like parts throughout the several views of the drawings.

### DETAILED DESCRIPTION OF THE PREFERRED EMBODIMENTS

The present invention facilitates providing necessary services such as lighting, surveillance and audio for applications such as gaming tables in a casino in an integrated audio, lighting and surveillance system. In one preferred embodiment, the integrated system has seven major parts: a base (or pit stand), four (4) support arms and two (2) wings. The integrated system preferably has the gaming table lights, the surveillance system, the audio system, the pit stand (with an integrated work light) and the ambient lighting in an all-in-one self-contained, free-standing assembly. In another preferred embodiment, the integrated system includes built-in game tracking and reporting systems. In yet another preferred embodiment, the integrated system may include a dealer calling systems. The integrated system can be modular so the gaming lights, surveillance cameras and audio speakers can easily be moved within the wings to accommodate many different games in many different combinations.

For example, one integrated system can provide all gaming systems for two large baccarat or craps tables. The same integrated system could be quickly reconfigured to provide support for four blackjack, roulette or mini-baccarat tables, or any combination of these tables.

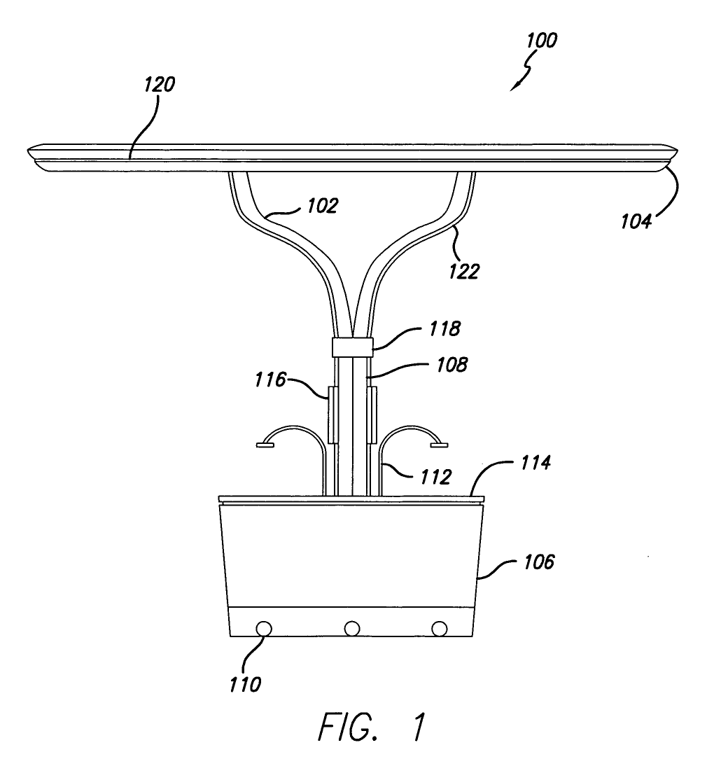

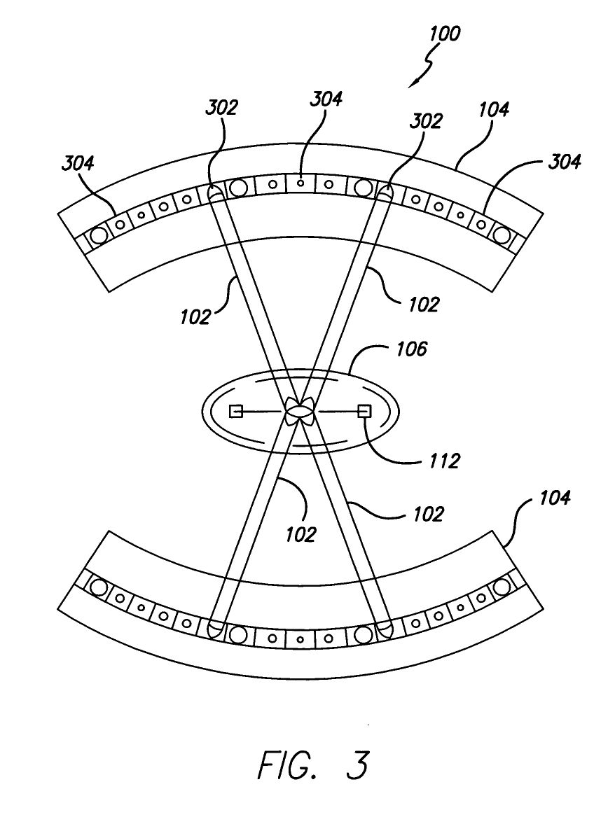

FIG. 1 is a front elevational view of an integrated audio, lighting and surveillance system 100 configured in accordance with a preferred embodiment of the present invention, including a set of arms 102 supporting a pair of wings 104 (as further described and illustrated in connection with FIG. 3) and attaching wings 104 to a base 106 through a support structure 108. As described further herein, wings 104 include a fiber-optic cable lighting system 120 for providing ambient light to the area surrounding integrated system 100.

Base 106 includes a set of hydraulic/pneumatic casters 110 for positioning of base 106. The use of casters 110 allows base 104 to be repositioned as necessary. For example, base 106 may be raised to reveal casters 110 for rolling the integrated system 100 and lowered to secure integrated system 100 once base 106 is in its desired location. In another embodiment, instead of raising base 106 to deploy casters 110, the casters may be permanently affixed and a set of supports (not shown) may be lowered to jack up base 106 when it is desired that base 106 be deployed in its permanent position. Preferably, integrated system 100 is secured to the ground or other fixed surface using bolts or other suitable fasteners.

Base 106 also includes a pair of light fixtures 112 used for the task lighting of a work surface 114. In addition, base 106 preferably contains much if not all of the electronics and power system for supporting integrated system 100, as described herein. For example, base 106 can include any power supplies and transformers necessary for the light fixtures, such as power supplies for halogen, fluorescent or other light fixtures. Further, base 106 can contain power conditioning and filtering systems, that can include battery back-up and uninterruptible power supply systems.

Integrated system 100 also includes a pair of light emitting diode (LED) gaming displays 116 for displaying information related to the gaming tables; a set of lighting fixtures 122 providing task lighting for the dealers of the gaming tables; as well as a set of fixed position security cameras 118 mounted to arms 102 and support structure 108 for general surveillance purposes.

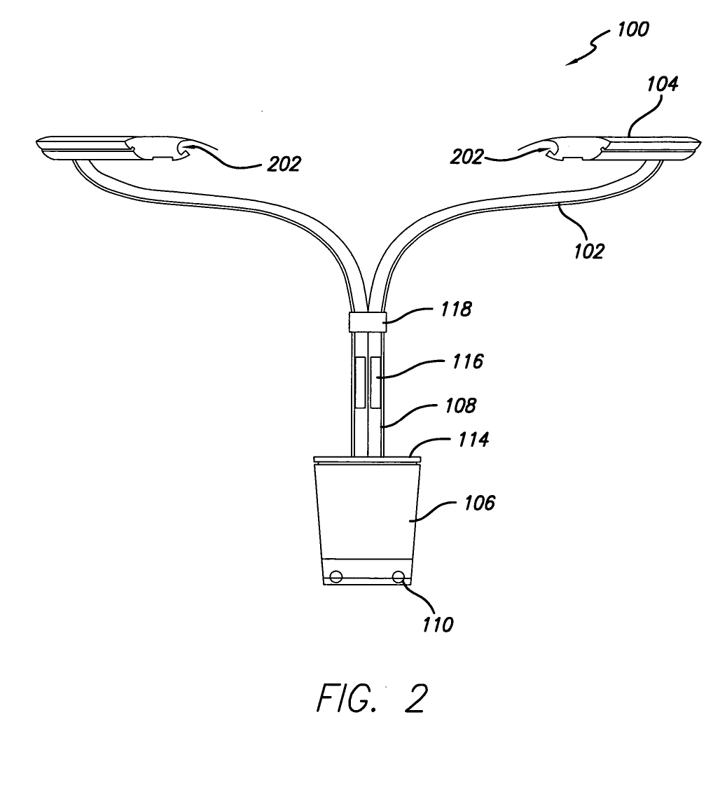

FIG. 2 is a side view of integrated system 100 of FIG. 1. As shown in FIG. 2 and further discussed herein, wings 104 include a reflector assembly 202 for providing diffused lighting to the work area. As shown in FIG. 2, preferably pair of wings 104 do not touch each other. However, in another embodiment, pair of wings 104 may touch each other and form one integral support structure. In yet another embodiment, pair of wings 104 may be in a different shape. And still in yet another embodiment, integrated system 100 may have any number of wings.

FIG. 3 is a top plan view of integrated system 100 shown in an exemplary configuration in accordance with one embodiment of the present invention with a cluster of interchangeable modules 304 and pair of wings 104, and a set of support connection caps 302 where arms 102 connect with pair of wings 104. As illustrated in FIG. 3, pair Wings 104, in one preferred embodiment is of a curved shape. However, in other embodiments, wings 104 may be straight or of any other shape. In addition, the placement and arrangement of the wings in both vertical and horizontal orientations may be different.

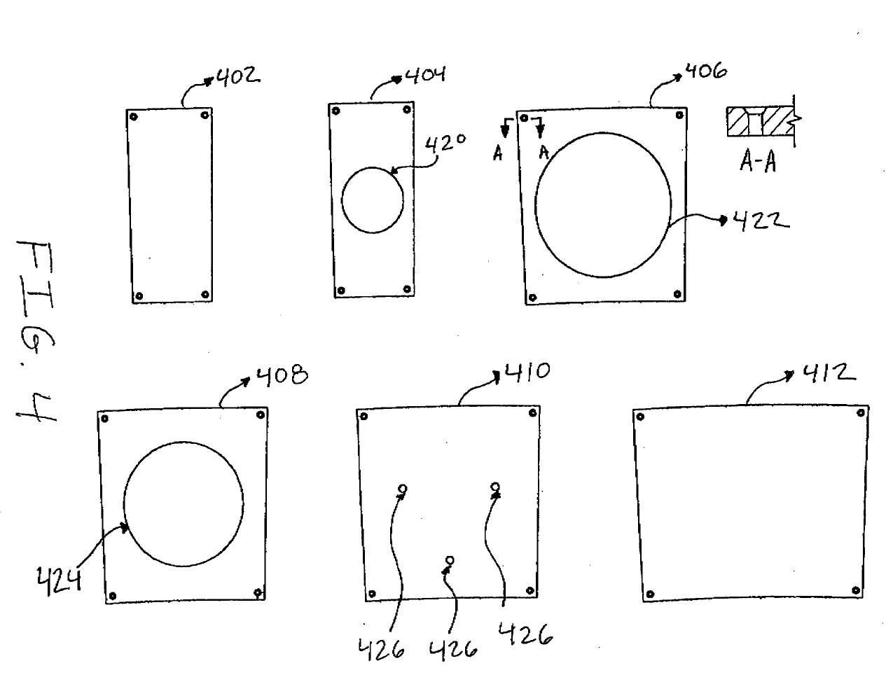

As seen in FIG. 3 and further discussed herein, pair of wings 104 may be outfitted with a plurality of modular parts to provide lighting, audio and surveillance features based on the specific desired configuration. In one embodiment, a minimum modular unit of a particular size is used as the basic “building block” for adding features to integrated system 100. Then, all other modules are sized based on the multiple of the minimum modular unit size. Further, specific locations may have different sizes as necessary for mounting nonstandard modules. For example, as seen in FIG. 3, arms 102 have ends 302 that are mounted to, as discussed below with reference to FIG. 4, module 410 of wings 104 that do not conform to a standard module size. Thus, a plate or module may be used that is a nonstandard size. In the alternative, a plate or module that is a multiple of the minimum modular size may be used.

FIG. 4 illustrates the various modules that may be used in integrated system 100, including a module 402, a lighting module 404, a camera module 406, a speaker module 408, a cover plate module 410, and an end piece module 412. Module 402 is the basic modular unit of the minimum size used in integrated system 100. Module 404 is an exemplary lighting module having an aperture 420 wherein a light fixture is located. In one embodiment, the light fixture is an adjustable pinhole accent light compatible with the type of lamps known as MR16 lamps, built into the modular panel of module 404. In another embodiment, the light fixture may be a spotlight. In yet another embodiment, the light future may be a diffused ambient light. Preferably module 404 is placed in the ideal location: above the gaming tables using anywhere from 6 to 12 lights per wing, depending on the gaming layout. Then, because the accent lights are adjustable, they can be adjusted to put the illumination where desired. Further, the selection of the industry standard MR16-type lamp allows an interior designer to select from the wide variety of beam spreads and wattages so that each table may be lit to the appropriate illumination level and contrast.

Module 406 is an exemplary camera module use in the surveillance system of integrated system 100. Module 406 includes an aperture 422, through which a color pan, tilt and zoom (PTZ) camera mounted in module 406 may capture images. In one embodiment, a glass plate is placed over aperture 422. In another embodiment, a dome (not shown) is used to cover the camera, which allows the lens of the camera to protrude from aperture 422 and capture a wider range of view. In yet another embodiment, a specialized lens, such as a “fish eye” lens, may be used, depending on the desired application.

Module 408 is a speaker module that includes an aperture 424 through which a speaker may project sound. In one embodiment, aperture 424 is covered with a speaker grille to cover the speaker mounted in module 408 for decorative and protective purposes, while allowing the audio projected therefrom to be heard. In another embodiment, where the speaker has a built-in grille, no covering for aperture 424 is necessary.

Module 410 is a cover plate for the location of wings 104, where arms 102 are connected to wings 104. Module 410 includes a set of attachment holes 426 for mounting ends 302 of arms 102. In one preferred embodiment, module 410 is of a nonstandard size, which means that the dimensions of module 410 is not an integral multiple of 402. Stated another way, the dimensions of the smallest module, module 402, may be taken as the smallest standard size. Multiples of any of these dimensions may be considered standard sizes. Similarly, module 412, which is an end piece for the ends of wings 104, is also of a nonstandard size. As discussed, the size and locations of the mounting of arms 102 and of the ends of wings 104 may be configured to such that modules of standard sizes may be used.

Although certain exemplary modules have been cited, no limitation should be placed on the type of modules that may be used in integrated system 100. For example, a module providing wireless networking or communication may be placed in wings 104, such as a wireless Ethernet transceiver. As another example, a fire alarm or a fire suppression system may be placed into wings 104 as one of the modules. In still yet another example, emergency lighting system may be integrated with integrated system 100 and implemented as one or more modules of wings 104. In still yet a further example, a blank module having dimensions of a multiple of module 402 may be used to add custom electronics or other features.

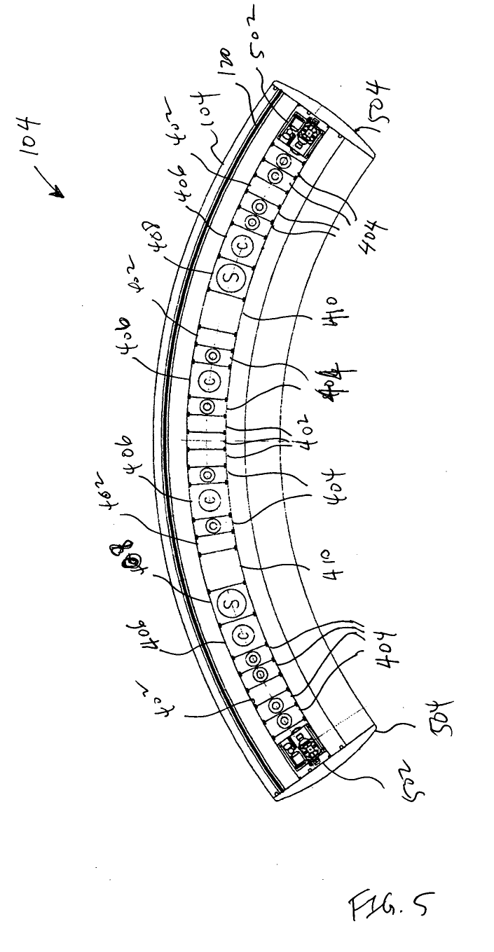

FIG. 5 is a bottom-up view of one of the wings 104 of the integrated system 100 configured in accordance with one embodiment of the present invention, which includes twelve lighting modules 404, four camera modules 406 and two speaker modules 408. The wing also includes seven base modules 402 along with two arm attachment modules 410 to provide proper spacing and attachment points for arms 102, respectively. FIG. 5 also illustrates a pair of fiber-optic lighting modules 502 for lighting fiber-optic lighting system 120. Typically, fiber-optic lighting modules 502 are covered by cover plate 412. Finally, a pair of end caps 504 is located on each end of the wing. It should be noted that although a specific configuration is shown in FIG. 5, any number of configurations in which the modules are able to be placed may be implemented as desired.

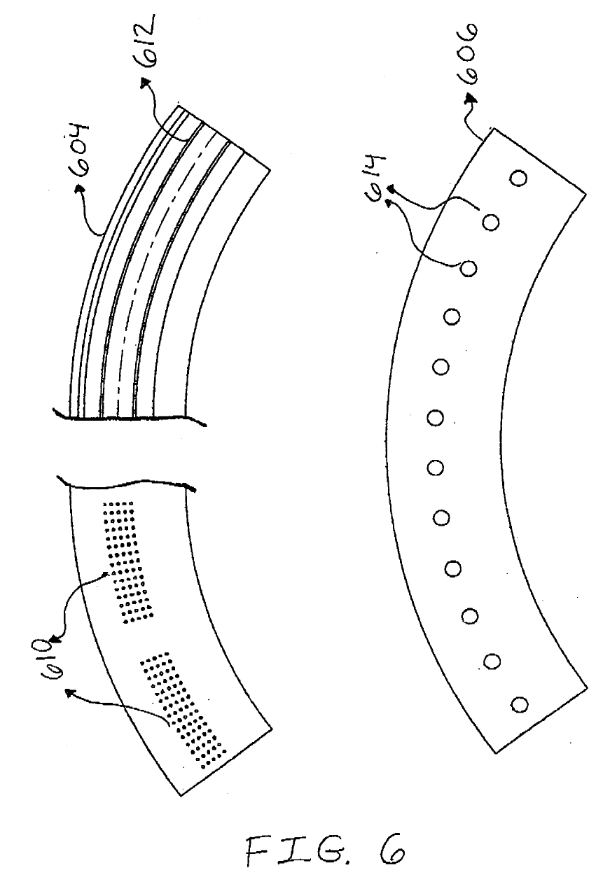

FIG. 6 illustrates the various embodiments of dust covers and ventilation grills that may be used with integrated system 100. The ventilation grills are placed on top of the top surface of wings 104. They provide protection from falling debris as well as limit the amount of dust that settles on the modules. In one embodiment, a ventilation grille 602 includes a set of ventilation holes 610 that are closely spaced together. In another embodiment, a ventilation grille 604 that includes an integrated dust cover with perforations 612 may be used. In yet another embodiment, a ventilation grille 606 with a set of ventilation holes 614 may be used to cover the components in wings 104. In still yet another embodiment, a combination of a ventilation grille in a particular configuration with or without a dust cover may be used.

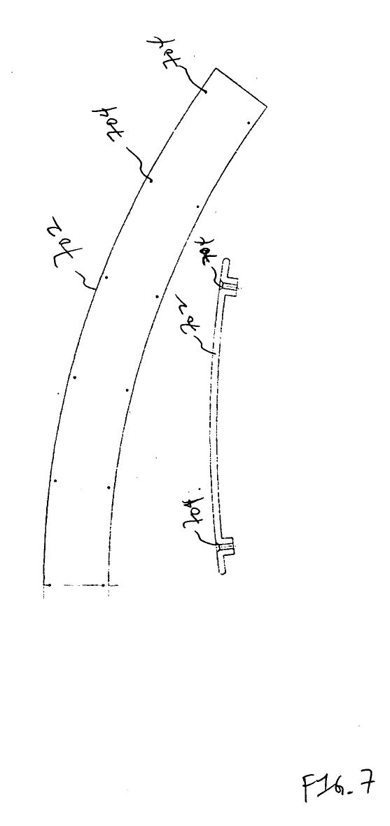

FIG. 7 illustrates a light diffusion panel 702 that may be used with integrated system 100. Specifically, diffuser 702 is used to cover fiber-optic cable lighting system 120 as further described below to diffuse the light coming from the fiber-optic cable. Diffuser 702 includes a set of mounting holes 704 for mounting to wings 104, as described herein.

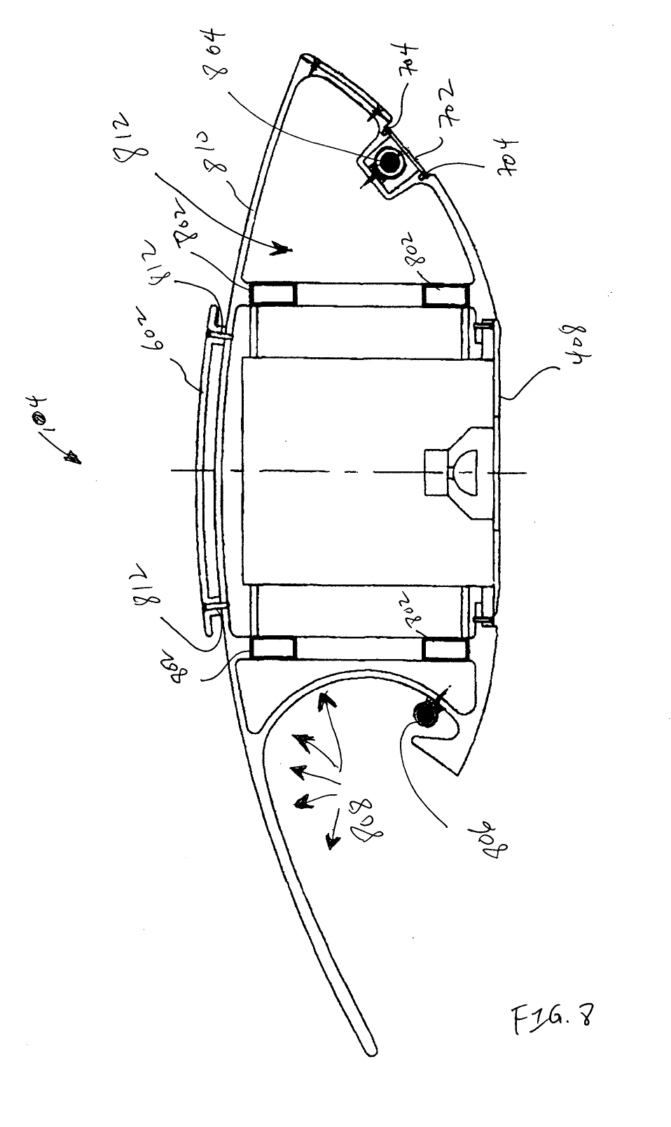

FIG. 8 is a cross-sectional view of one of the wings of wings 104 of integrated system 100 of FIG. 1, where a frame 802 surrounded by a shell 810 is illustrated. In one embodiment, frame 802 is constructed of a metal such as aluminum, while shell 810 is constructed using a material such as fiberglass. In other embodiments, frame 802 is constructed of a material of sufficient rigidity to support shell 810 and the modular components.

Shell 810 includes a reflector (or cove) 808 for diffusing and reflecting the light produced by a fiber-optic cable 806. In one preferred embodiment, fiber-optic cable 806 is located in within a curved portion of shell 810 such that fiber-optic cable 806 is not directly exposed. This is to prevent glare from the linear light source being exposed directly on a person viewing the light from the fiber-optic cable 806. Shell 810 also includes a second fiber-optic cable 804 to provide ambient light through diffuser 702, as discussed above. In one preferred embodiment, fiber-optic cable 806 is oriented to provide ambient light, as reflected and dispersed by reflector 808, for the area surrounding base 106. In addition, fiber-optic cable 804 provides ambient light for the walkways near the gaming tables serviced by integrated system 100. In one embodiment, fiber-optic cable 806 and second fiber-optic cable 804 use linear, edge emitting fiber-optics to create ambient light sources. An example of such a fiber-optic is the Sta-Flex® LEF™ 510M or 710M linear emitting fibers, manufactured by Lumenyte International Corp. In another embodiment, light sources such as neon or light emitting diodes may be used.

As seen in FIG. 8, lighting module 408 is mounted within frame 802 and is covered by ventilation cover 602. Shell 810 includes a wireway 812 for running prewired connectors so that new modules can be added and wired without having to pull additional cabling through shell 810.

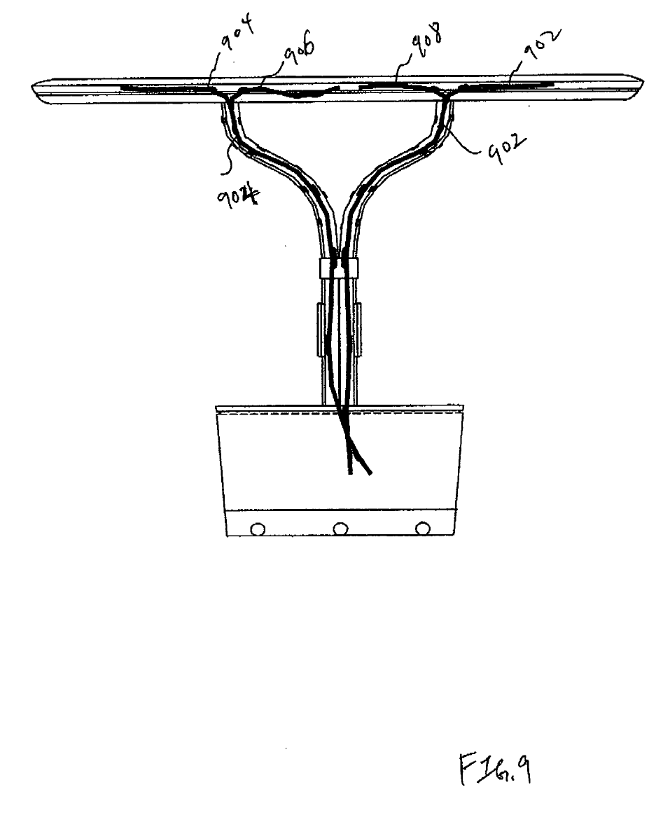

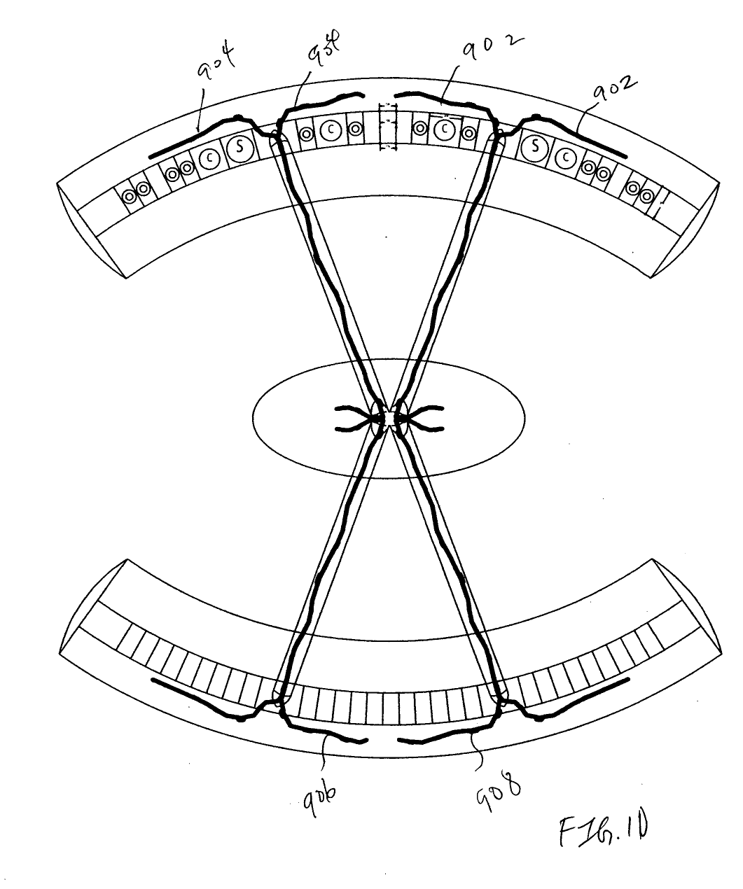

FIGS. 9 and 10 are elevational and top plan views of an exemplary wiring/cable run for the components of integrated system 100. As shown in the figures, four sets of cables 902, 904, 906 and 908 are used to carry electricity and other signals to the modules located in wings 104. As previously discussed, the wires are routed through wireway 812 in body 810 of wings 104. Preferably, the cables and wires are routed to wings 104, with multiple wire ends dispersed along the lengths of wings 104 to provide flexibility in the arrangement and number of modules. In one embodiment, set of cables 902 include wires to supply power and data to the light fixtures in wings 104. In another embodiment, other types of cables suitable for carrying data, such as fiber-optic cables, may be used. As used herein, the term data includes audio and video information in either digital or analog format, as well as other information that may need to be communicated.

As discussed herein, two optional systems may be added to integrated system 100 to support gaming functions: a built-in game tracking system and/or a built-in dealer calling system. The game tracking system is built into arms 102 that rise out of base 106 (the pit stand) to support wings 104, and include display 116. Information regarding the particular game is displayed on displays 116. For example, if the gaming table is a roulette table, the display in one embodiment may display a list of the last ten numbers. To customize the information being displayed, the game tracking system is plugged into the new table and the display is automatically adjusted to provide the type of information related to the new game. Further, the dealer calling system functionality is provided by adding an audio signal distribution box (not shown) in the pit stand, a dealer headset coupled to the audio signal distribution box (either wirelessly or wired) and the necessary coupling of cables. The dealer simply puts on the headset and plugs it into the table, the players will then hear the dealer's voice amplified through the speaker over their head. The volume is automatically adjusted so that the players at one table will not hear the dealer from any of the surrounding tables.

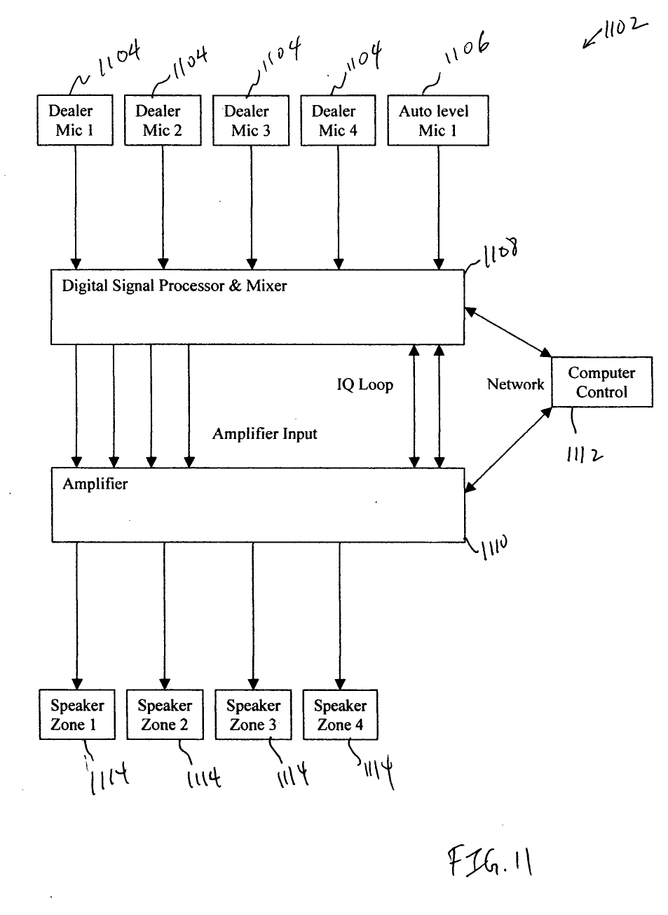

FIG. 11 is a block diagram of an audio system 1102 configured in accordance with one embodiment of the present invention for use in integrated system 100. Audio system 1102 allows not only the delivery of music and entertainment audio, but also allows the dealers to broadcast information regarding the games. Audio system 1102 includes a set of dealer microphones 1104 coupled to a digital signal processor and mixer 1108, which captures the analog signals from the microphones and converts it into a digital format. The signals are then sent to amplifier 1110 for broadcasting to set of speakers 1114. Audio system 1102 also includes an audio level microphone 1106, which is a sound level detection microphone that detects the ambient noise level and adjusts the amplification accordingly. In one embodiment, multiple digital signal processor and mixers, as well as amplifiers may be connected via a network, and fall under control using a computer such as computer controller 1112.

In one embodiment, audio and audio information is communicated between devices using a digital audio transport technology such as CobraNet™, developed by Peak Audio, Inc. CobraNet works by taking an analog waveform and converting it into digital form (i.e., ones and zeroes). Once the audio signal is converted to digital form, it is then transported over a 100 Megabit or faster Ethernet network. Once the information is transported over the network, it may be received by an amplifier that can perform the conversion from digital to analog format and replay the information on the speaker modules. In one embodiment, up to 64 channels can be sent in a 100 Megabit line using the CobraNet™ system. The system offers addressing of audio information, which allows the security and surveillance system operator the ability to select and control uniquely identifiable sources. Specifically, audio system 1112 is a computerized audio system that uses standard control protocols to allow remote control and monitoring of audio information from a central location and/or remote locations. In other embodiments, custom audio digitization, storage, retrieval, and playback components may be used.

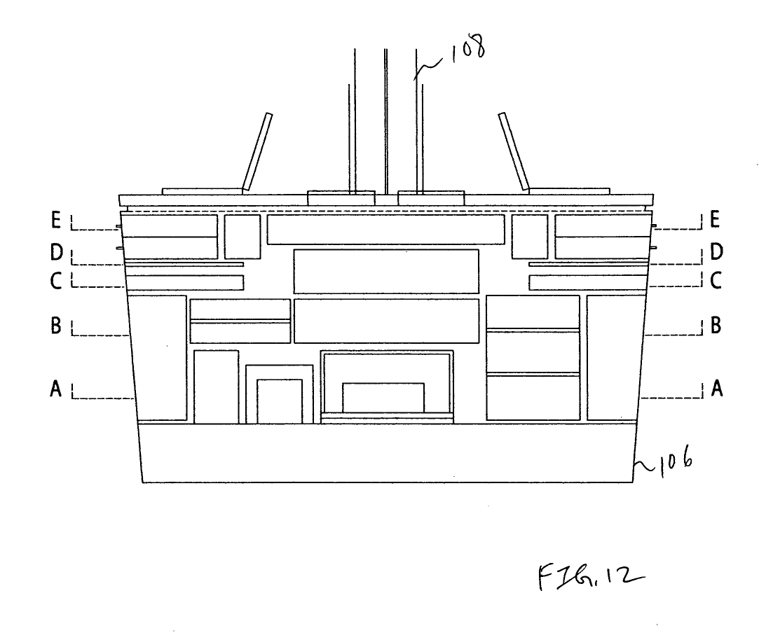

FIG. 12 is an elevational cross-section view of base 106 configured in accordance with one embodiment of the present invention for use in integrated system 100. In the embodiment described herein, base 106 is configured for use in support of a cluster of gaming tables. Thus, base 106 and integrated system 100 is located in a “pit” area.

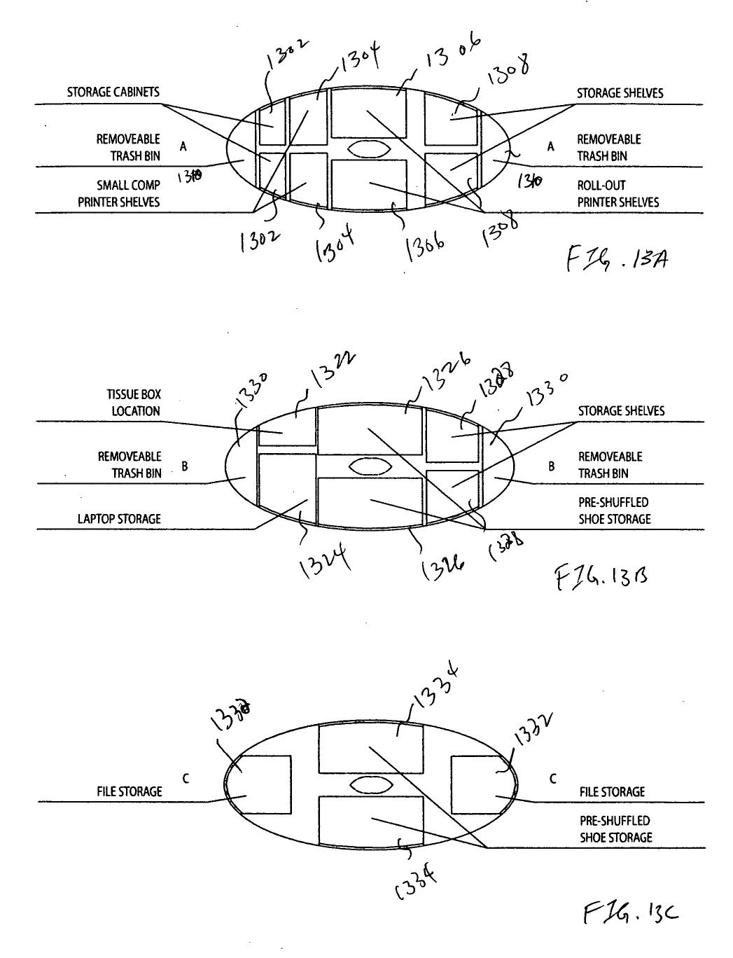

FIGS. 13A-13E are cross-sectional views taken along lines A-A, B-B, C-C, D-D, and E-E, respectively, of base 106 as shown in FIG. 12. In FIG. 13A, a set of storage cabinets 1302 is provided for storing miscellaneous objects; a pair of small computer printer shelves 1304 are used to house two small computer printers; a pair of roll out printer shelves 1306 are used to store two printers; a pair of storage shelves 1308 are used to provide shelves for holding objects; and a pair of removable trash bins 1310 are provided for the storage of refuse.

In FIG. 13B, another pair of removable trash bins 1330 are provided in base 106 for the storage of refuse; a tissue box location 1322 is provided for the storage of tissue; a laptop storage 1324 is provided for the storage of a laptop computer; a pair of storage locations for pre-shuffled shoes 1326 are provided for storing card shoes; and another pair of storage shelves 1328 are provided for additional storage space.

In the cross-section of base 106 of FIG. 13C, a pair of file storage locations 1332 are provided along with another pair of card shoe storage 1334; while in FIG. 13D, a pair of pull out shelves for sit-down laptop usage 1342 are provided along with yet another pair of pre-shuffled shoe storage locations 1344.

FIG. 13E illustrates the provision of a pair of storage drawers 1352; a set of storage shelves 1354; and a pair of baccarat chip tray lid or other storage location 1356.

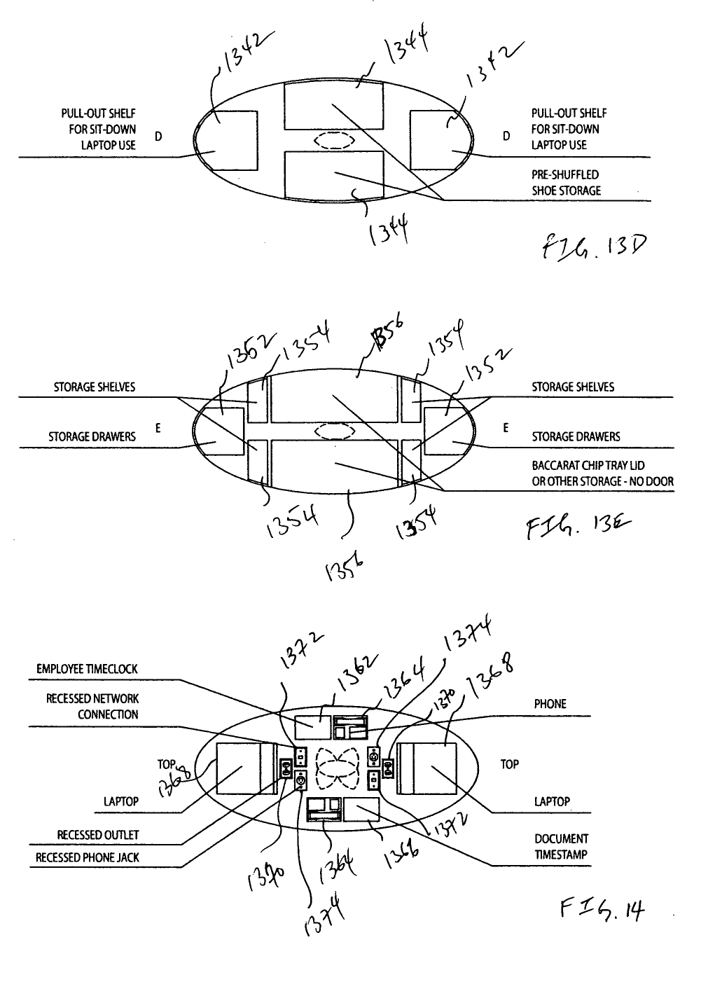

FIG. 14 is a top plan view of the configuration of the table surface of base 106, where it is shown that a pair of laptops 1368 are mounted to the top of base 106 along with a pair of telephones 1364; an employee time clock 1362; a document timestamp device 1366 and a full complement of recessed power outlets 1370, recessed telephone jacks 1370, and recessed network connections 1372 are provided. It should be noted that although a specific configuration of the features of base 106 has been described herein, other configurations are contemplated and should be considered to fall within the scope of the present disclosure.

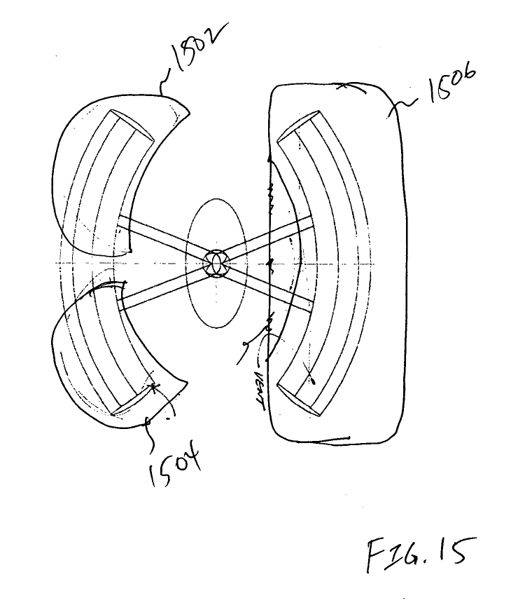

FIG. 15 is a top plan view of integrated system 100 used with an exemplary configuration of gaming tables, including a pair of blackjack tables 1502/1504 and a roulette table 1506. In another embodiment, integrated system 100 may be used to support two roulette tables or four blackjack tables. In still yet another embodiment, integrated system 100 may be used to support any combination of tables and games.

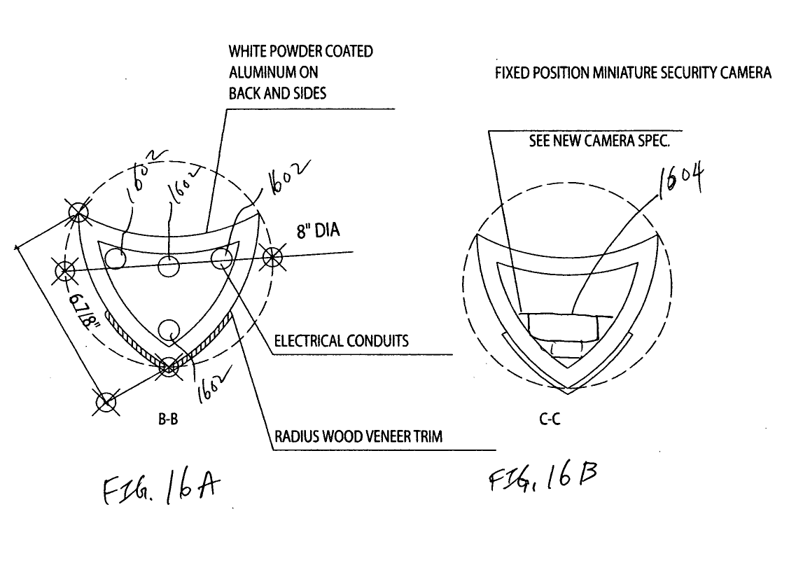

FIG. 16A is a cross-sectional view of one arm of set of arms 102 configured in accordance with one embodiment of the present invention for use in integrated system 100. The arm includes a set of electrical conduits 1602 that are used to route the various cables and signal lines discussed herein. FIG. 16B is a cross-sectional view of one end-cap of one arm of set of arms 102 configured in accordance with one embodiment of the present invention for use in integrated system 100. The end-cap includes a fixed-position miniature security camera 1604.

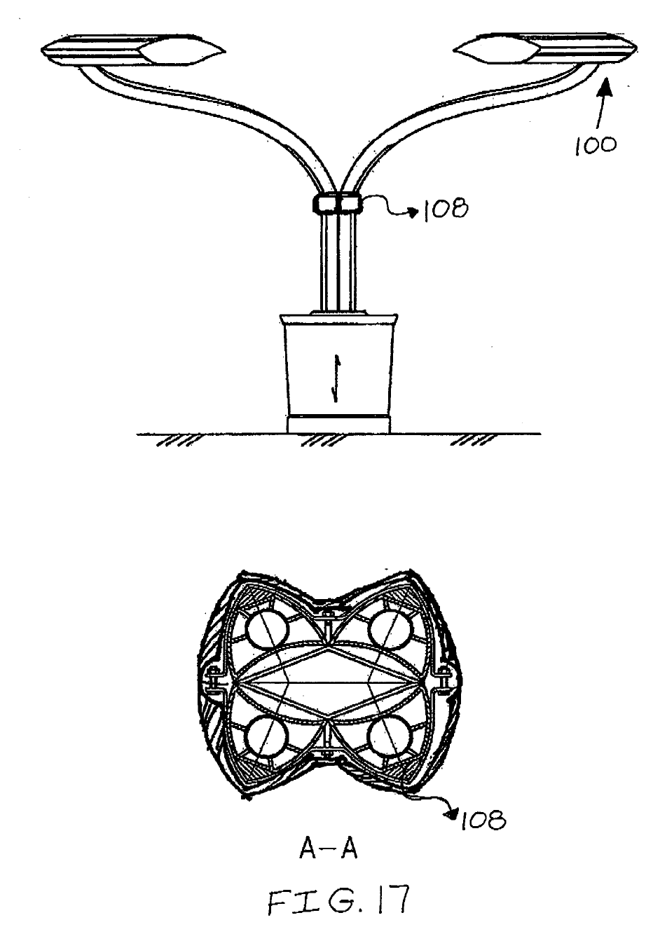

FIG. 17 is a cross-sectional view of support structure 108 configured in accordance with one embodiment of the present invention along with a side elevation view of its placement in integrated system 100.

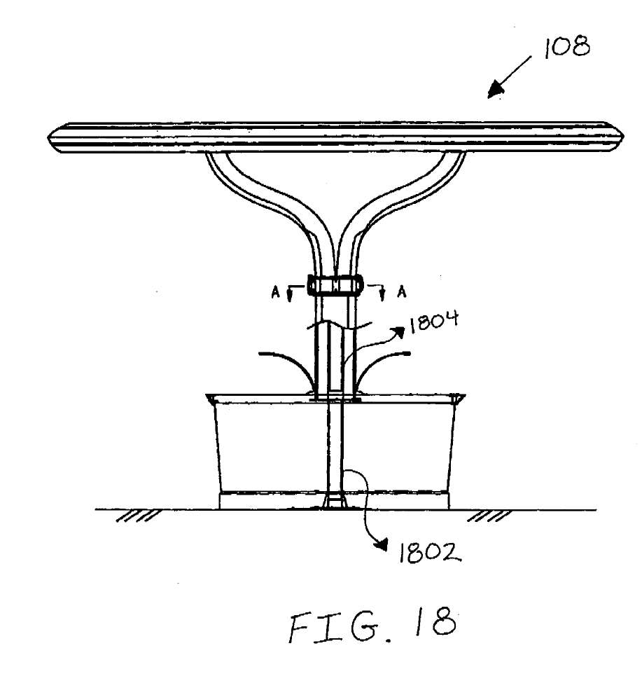

FIG. 18 is a side elevational view of integrated system 100 illustrating the integration of an internal support structure 1802 configured in accordance with one embodiment of the present invention. In one embodiment, internal support structure 1802 is bolted to the floor to provide maximum stability when base 106 is to be secured in its present location.

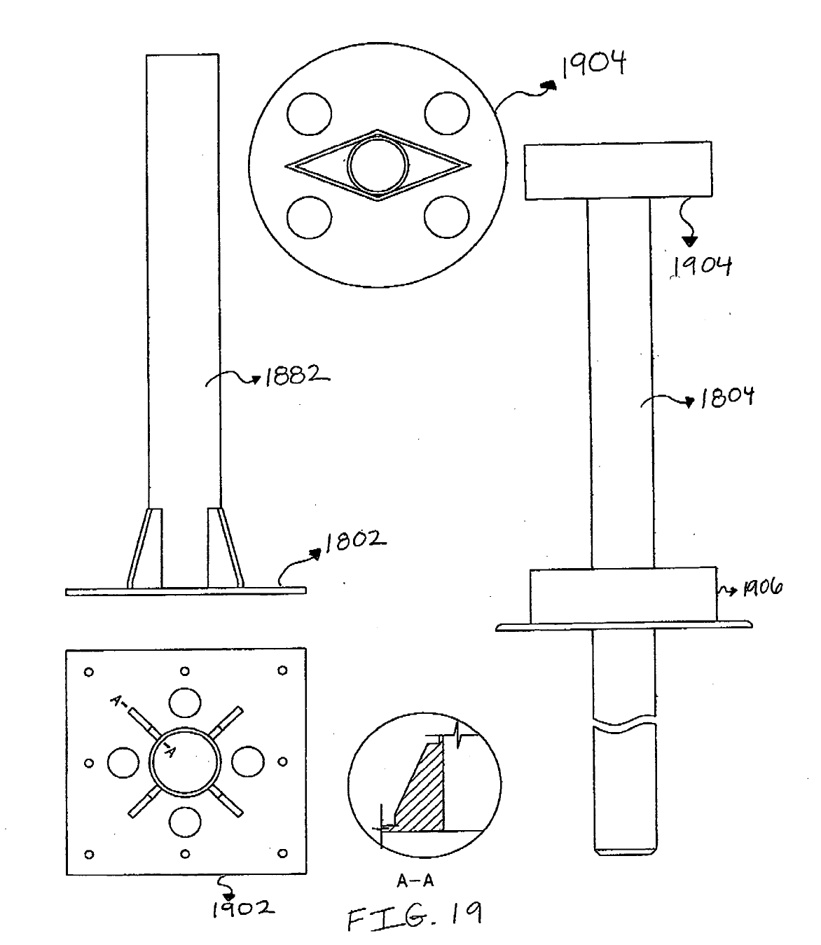

FIG. 19 illustrates the parts of internal support structure 1802, including a bottom baseplate 1902 supporting internal support structure 1802, which is coupled to an upper internal support structure 1804. A support bracket 1906 is fixed to the table of base 106, while a top support bracket 1904 is connected to support structure 108.

The embodiments described above are exemplary embodiments of a the present invention. Those skilled in the art may make numerous uses of, and departures from, the above-described embodiments without departing from the inventive concepts disclosed herein. Accordingly, the present invention is to be defined solely by the scope of the following claims.

1. An integrated audio, lighting and surveillance system comprising:
a base;
a support structure mounted to the base; and,
a component enclosure mounted on the support structure, the component enclosure having a series of mounting locations, each mounting location configured to receive a modular component usable for supporting a gaming table.

2. The integrated audio, lighting and surveillance system of claim 1, wherein the mounting locations are spaced equally apart.

3. The integrated audio, lighting and surveillance system of claim 1, wherein the modular components are sized to fit one or more mounting locations.

4. The integrated audio, lighting and surveillance system of claim 1, further comprising a game tracking system.

5. The integrated audio, lighting and surveillance system of claim 1, wherein the modular component is selected from a group consisting of a camera, a light fixture, an audio speaker, a microphone, a fire suppression system, a fire detection system, a communications device, a power supply, and an alert system.

6. The integrated audio, lighting and surveillance system of claim 1, further comprising an ambient light source.

7. The integrated audio, lighting and surveillance system of claim 6, wherein the component enclosure comprises a channel and the ambient light source is mounted within the channel.

8. The integrated audio, lighting and surveillance system of claim 6, wherein the component enclosure comprises a curved portion and the ambient light source is mounted within the curved portion.

9. The integrated audio, lighting and surveillance system of claim 6, wherein the component enclosure comprises a cove and the ambient light source is mounted within the cove.

10. The integrated audio, lighting and surveillance system of claim 6, wherein the component enclosure comprises a diffuser and the ambient light source is mounted behind the diffuser.

11. The integrated audio, lighting and surveillance system of claim 1, further comprising a frame structure, the frame structure being integrated into the component enclosure.

12. The integrated audio, lighting and surveillance system of claim 1, wherein the component enclosure is a curved wing.

13. The integrated audio, lighting and surveillance system of claim 1, wherein the base includes at least one element selected from the group consisting of a drawer, a shelf, a time clock, a printer, a card reader, a computer, a phone, a network jack, a power outlet and a phone jack.

14. The integrated audio, lighting and surveillance system of claim 1, further comprising a display.

15. The integrated audio, lighting and surveillance system of claim 14, wherein the display is configured to display gaming information.

16. The integrated audio, lighting and surveillance system of claim 1, wherein the component enclosure further comprises a cover having at least one ventilation opening.

17. The integrated audio, lighting and surveillance system of claim 1, wherein the component enclosure includes a length of fiber-optic running along at least a portion of the enclosure.

18. The integrated audio, lighting and surveillance system of claim 1, further comprising a hydraulic jack system for deploying a set of casters.

19. The integrated audio, lighting and surveillance system of claim 18, wherein the hydraulic jack system deploys the casters by lowering the casters from the base.

20. The integrated audio, lighting and surveillance system of claim 1, further comprising an audio signal transport system.

21. The integrated audio, lighting and surveillance system of claim 1, further comprising a wireway.

22. An integrated audio, lighting and surveillance system comprising:
a base;
a support structure mounted to the base; and,
a component enclosure mounted on the support structure; the component enclosure having a series of mounting panels, each panel configured to receive a modular component configured to support a gaming table.

23. The integrated audio, lighting and surveillance system of claim 22, wherein each panel being of a standard size.

24. The integrated audio, lighting and surveillance system of claim 22, wherein each panel being one of a set of standard sizes, each standard size being a multiple of a smallest of one of the set of standard sizes.

25. The integrated audio, lighting and surveillance system of claim 22, wherein each panel being one of a first standard size and a second standard size, wherein the second standard size is different from the first standard size.

26. The integrated audio, lighting and surveillance system of claim 22, further comprising a game tracking system.

27. The integrated audio, lighting and surveillance system of claim 22, wherein the modular component is selected from a group consisting of a camera, a light fixture, an audio speaker, a microphone, a fire suppression system, a fire detection system, a communications device, a power supply, and an alert system.

28. The integrated audio, lighting and surveillance system of claim 22, further comprising an ambient light source.

29. The integrated audio, lighting and surveillance system of claim 28, wherein the component enclosure comprises a channel and the ambient light source is mounted within the channel.

30. The integrated audio, lighting and surveillance system of claim 28, wherein the component enclosure comprises a curved portion and the ambient light source is mounted within the curved portion.

31. The integrated audio, lighting and surveillance system of claim 28, wherein the component enclosure comprises a cove and the ambient light source is mounted within the cove.

32. The integrated audio, lighting and surveillance system of claim 28, wherein the component enclosure comprises a diffuser and the ambient light source is mounted behind the diffuser.

33. The integrated audio, lighting and surveillance system of claim 22, further comprising a frame structure, the frame structure integrated into the component enclosure.

34. The integrated audio, lighting and surveillance system of claim 22, wherein the component enclosure is a curved wing.

35. The integrated audio, lighting and surveillance system of claim 22, wherein the base includes at least one element selected from the group comprising of a drawer, a shelf, a time clock, a printer, a card reader, a computer, a phone, a network jack, a power outlet and a phone jack.

36. The integrated audio, lighting and surveillance system of claim 22, further comprising a display.

37. The integrated audio, lighting and surveillance system of claim 36, wherein the display is configured to display gaming information.

38. The integrated audio, lighting and surveillance system of claim 22, wherein the component enclosure further comprises a cover having at least one ventilation opening.

39. The integrated audio, lighting and surveillance system of claim 22, wherein the component enclosure includes a length of fiber-optic cable running along at least a portion of the enclosure.

40. The integrated audio, lighting and surveillance system of claim 22, further comprising an hydraulic jack system for deploying a set of casters.

41. The integrated audio, lighting and surveillance system of claim 40, wherein the hydraulic jack system deploys the casters by lowering the casters from the base.

42. The integrated audio, lighting and surveillance system of claim 22, further comprising an audio routing system.

43. The integrated audio, lighting and surveillance system of claim 22, further comprising wireway.

44. A configurable lighting system for a gaming table comprising a plurality of modular task lighting fixtures and an ambient lighting system having a fiber-optic cable.

45. A method comprising the steps of:
providing a free-standing structure having a base, a component enclosure having a plurality of mounting locations for mounting modular components, and a support structure coupling the component enclosure to the base;
selecting a component from a group consisting of a camera, a light fixture, an audio speaker, a microphone, a fire suppression system, a fire detection system, a communications device, a power supply, and an alert system; and,
installing the component in the component enclosure.

46. An enclosure comprising:
a frame; and,
a body mounted to the frame, the body having a plurality of locations for installing a plurality of component modules, the plurality of locations being spaced at a predetermined distance apart;
wherein the plurality of component modules include at least one component selected from a group consisting of a camera, a light fixture, an audio speaker, a microphone, a fire suppression system, a fire detection system, a communications device, a power supply, and an alert system.

47. The enclosure of claim 46, within the body includes a wireway.

48. The enclosure of claim 46, further comprising a cover mounted to a top surface of the body.

49. The enclosure of claim 48, wherein the cover comprises a set of perforations.

50. The enclosure of claim 46, wherein the body surrounds the frame and the plurality of locations are openings in the body.

51. The enclosure of claim 46, further comprising a plurality of mounting locations configured for attachment to a support.

52. The enclosure of claim 51, wherein the support is a, base.

53. The enclosure of claim 51, wherein the support structure is a fixed surface.
